(19) United States
(12) Patent Application Publication
(10) Pub. No.: US 2009/0221767 A1
(43) Pub. Date: Sep. 3, 2009

(54) NOVEL USE OF A COPOLYMER COMPRISING POLYAMIDE BLOCKS AND POLYETHER BLOCKS ORIGINATING AT LEAST PARTIALLY FROM POLYTRIMETHYLENE ETHER GLYCOL

(75) Inventor: Frederic Malet, Rouen (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, COLOMBES (FR)

(21) Appl. No.: 12/279,578

(22) PCT Filed: Feb. 16, 2007
(86) PCT No.: PCT/FR07/50817

§ 371 Date: Feb. 19, 2009

Related U.S. Application Data
(60) Provisional application No. 60/784,355, filed on Mar. 21, 2006.

(30) Foreign Application Priority Data
Feb. 16, 2006 (FR) 0601354

(51) Int. Cl. C08L 53/00

(52) U.S. Cl. 525/92 A

(57) ABSTRACT

Use of a copolymer comprising polyamide blocks and polyether blocks of the general formula (I)

-[PA-PE]ₙ-

in which
PA represents a polyamide block;
PE represents a polyether block; and
n represents the number of -PA-PE- units of the said copolymer,
   and in which at least 10% by weight of the PE blocks originate from polytrimethylene ether glycol, for applications involving the hydrophilic nature and the low melting point of the polytrimethylene ether.

The present invention relates to a novel use of a copolymer comprising polyamide blocks and polyether blocks, the latter being at least partially of polytrimethylene ether glycol (abbreviated to PO3G).

In poly(ether-block-amide) (PEBA) blocks, the polyamide blocks are known to be rigid segments whereas the polyether blocks are flexible segments.

Copolymers comprising polyamide (PA) blocks and polyether (PE) blocks or copolymers comprising PA and PE blocks, abbreviated to PEBA, result from the copolycondensation of polyamide sequences comprising reactive ends with polyether sequences comprising reactive ends, such as, inter alia, of:
(1) polyamide sequences comprising diamine chain ends with polyoxyalkylene sequences comprising dicarboxyl or diisocyanate chain ends;
(2) polyamide sequences comprising dicarboxyl chain ends with polyoxyalkylene sequences comprising diamine chain ends obtained by cyanoethylation and hydrogenation of aliphatic α,ω-dihydroxylated polyoxyalkylene sequences, referred to as polyetherdiols;
(3) polyamide sequences comprising dicarboxyl chain ends with polyetherdiols, the products obtained being, in this specific case, polyetheresteramides.

The polyamide sequences comprising dicarboxyl chain ends originate, for example, from the condensation of precursors of polyamides in the presence of a chain-regulating dicarboxylic acid.

The polyamide sequences comprising diamine chain ends originate, for example, from the condensation of precursors of polyamides in the presence of a chain-regulating diamine.

The polymers comprising polyamide blocks and polyether blocks can also comprise units distributed randomly. The said polymers can be prepared by the simultaneous reaction of the polyether and of the precursors of the polyamide blocks.

For example, polyetherdiol, polyamide precursors and a chain-regulating diacid can be reacted or polyetherdiamine, polyamide precursors and a chain-regulating diacid can also be reacted. A polymer is obtained which has essentially polyether blocks, polyamide blocks of highly variable length, depending on the point at which the chain regulator becomes involved during the formation of the PA block, but also the various reactants which have reacted randomly and which are distributed randomly (statistically) along the polymer chain.

There are advantageously two types of polyamide blocks present in the copolymers comprising PA and PE blocks according to the invention. The polyamide block can be composed of a “homopolyamide” structure [polymerization of the single monomer, namely a single lactam, a single [[amino acid or a single pair (diacid, diamine)] or of a structure of “copolyamide” type with the polymerization of a mixture of at least two monomers taken from the three types mentioned in the preceding case.

The polyamide blocks are obtained in the presence of a chain-regulating diacid or diamine, depending on whether polyamide blocks respectively comprising acid or amine ends are desired. If the precursors already comprise a diacid or a diamine, it is sufficient, for example, to use it in excess but it is also possible to use another diacid or another diamine taken from the groups of dicarboxylic acids and of diamines defined below.

French Patent Application FR 88 15441 teaches a waterproof-breathable film based on polyetheresteramide, in particular of PA 12—polytetramethylene glycol (PTMG). These waterproof-breathable films, essentially made of polyetheresteramides, have the disadvantage, when they are highly permeable, of having a high moisture uptake which causes them to swell and renders them brittle.

Another problem is the excessively low water uptake and the reduction in the permeability to water vapour.

The document WO 97/26020 describes scented resins composed of a polymer resin of polyetheresteramide type which makes possible the uniform diffusion of volatile substances. This document does not disclose selective diffusion of gases.

The document WO 02/02696 describes thermoplastic polymer compositions comprising a polyamide and at least one PEBA which is a compound which modifies the hydrophilicity and/or the antistatic behaviour.

The document EP 0 476 963 relates to a blend of polymers comprising PEBA having predominant polyether blocks made of PEG and a PEBA having polyether blocks not comprising PEG but based on PTMG or PPG.

The Applicant Company has now discovered that the polyether blocks resulting from polytrimethylene ether glycol have novel uses.

This is because the PO3G-based PEBA polymer according to the invention exhibits not only properties of improving the resistivity of insulating matrix but also better:
(i) waterproof-breathable properties,
(ii) gas selective diffusion properties, that is to say that some gases can pass through a membrane made with the said polymer, in contrast to others, and/or
(iii) properties of modification of mechanical properties of polymer or polymer compositions to which they are added than the products of PTMG-based PEBA type.

The subject-matter of the present invention is thus the use of a copolymer comprising polyamide blocks and polyether blocks of the general formula

-[PA-PE]ₙ- (I)

in which
PA represents a polyamide block;
PE represents a polyether block; and
n represents the number of -PA-PE- units of the said copolymer,
   and in which
the said blocks originate either entirely from polytrimethylene ether glycol (PO3G) or they originate from a blend or a copolymer of PO3G and of at least one from polyethylene ether glycol (PEG), polypropylene ether glycol (PPG), polytetramethylene ether glycol (PTMG), polyhexamethylene ether glycol and copolymers of tetrahydrofuran (THF) and of 3-alkyltetrahydrofuran (3MeTHF);
   as waterproof-breathable product or as additive conferring water-breathable properties on thermoplastic polymers in order to form a membrane for selective diffusion according to the nature of the gas;
   as additive in polyamide 6, polyamide 6.6 or copolyamide based on 6/6.6 intended to be converted to a film in order to improve the mechanical properties and/or the convertibility of the said polyamide.

According to one embodiment, the said PE blocks have a molecular weight<800.

According to one embodiment, the said PE blocks have a molecular weight of at least 250.

According to one embodiment, the said PE blocks have a molecular weight of between 250 and 650.

According to one embodiment, the copolymer is characterized in that at least 10%, preferably at least 20%, more preferably still at least 30%, advantageously at least 50%, more advantageously still at least 75% and more preferably 85 to 100% by weight of the PE blocks originate from polytrimethylene ether glycol (% by weight with respect to the total weight of the said PE blocks).

The percentage by weight of PA blocks with respect to the total weight of the said copolymer is in particular at least 10%, more preferably at least 15% and preferably it ranges up to 90%, more preferably between 40 and 60%.

The PA blocks have in particular a number-average molecular weight of at least 300, preferably of at least 600 and preferably ranging up to 10,000, more preferably up to 5000 and more preferably still up to 3000.

n ranges from 1, being in particular at least 5, more preferably at least 6 and ranging up to a mean of 60, preferably up to a mean of 30 and more preferably up to a mean of 25.

The PA blocks are in particular with carboxyl ends, so that the bonds between the PA and PE blocks are ester bonds.

The PA blocks comprising carboxyl ends can be the condensation product of a lactam, in particular of a C₄-C₁₄ lactam, of an amino acid, in particular of a C₄-C₁₄ amino acid, or of a combination of the two with a dicarboxylic acid, in particular a C₄-C₂₀ dicarboxylic acid.

Mention may be made, as examples of lactams, of caprolactam, enantholactam and lauryllactam.

Mention may be made, as examples of amino acids, of aminocaproic, 7-aminoheptanoic, 11-aminoundecanoic and 12-aminododecanoic acids.

Mention may be made, as examples of dicarboxylic acids, of 1,4-cyclohexanedicarboxylic acid, butanedioic acid, adipic acid, azelaic acid, suberic acid, sebacic acid, dodecanedicarboxylic acid, terephthalic acid and isophthalic acid but also dimerized fatty acids.

The PA blocks comprising carboxyl ends can also be the condensation product of a dicarboxylic acid, such as a (C₄-C₂₀ alkane)dicarboxylic acid, and of a diamine, in particular of a C₂-C₂₀ diamine.

Examples of dicarboxylic acids have been shown above.

Mention may be made, as examples of diamines, of hexamethylenediamine, dodecamethylenediamine, trimethylhexamethylenediamine, isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine.

In particular, the PA blocks can be chosen from PA 6, PA 11, PA 12, PA 6,6, PA 6,9, PA 6,10, PA 6,12, PA 6,14, PA 6,18, PA Pip,10 and PA 9,6 blocks.

The PE blocks originate either entirely from polytrimethylene ether glycol (PO3G) or they originate equally advantageously from PO3G and from at least one from polyethylene ether glycol (PEG), polypropylene ether glycol (PPG), polytetramethylene ether glycol (PTMG), polyhexamethylene ether glycol and copolymers of tetrahydrofuran (THF) and of 3-alkyltetrahydrofuran (3MeTHF). It is also possible to envisage a PE block of “copolyethers” type comprising a sequence of PE blocks of the abovementioned types. The chain ends of the copolyethers can be diOH, diNH₂, diisocyanate or diacid, depending on their method of synthesis.

The polyether glycols in addition to PO3G in the PE block have an average molar mass such that the PE block comprising them has an average molar mass of at least approximately 800, more preferably of at least approximately 1000 and preferentially of at least approximately 1500. Moreover, preferably at least approximately 50% by weight, more preferably at least 75% by weight and more preferentially approximately 85 to 100% by weight of the polyether glycol used to form the PE block is PO3G.

The present invention relates more specifically to the use of a copolymer of formula (I) as defined above as antistatic product or as additive conferring antistatic properties on thermoplastic polymers, such as polyamides, or on elastomers.

The present invention also relates more particularly to the use of a copolymer of formula (I) as defined above as waterproof-breathable product or as additive conferring water-breathable properties on thermoplastic polymers, such as polyamides, or on elastomers.

The present invention also relates more particularly to the use of a copolymer of formula (I) as defined above in forming a membrane for selective diffusion according to the nature of the gas.

In particular, the copolymer of formula (I) can be used as additive in polyamide 6, polyamide 6,6 or a copolyamide based on 6/6,6 intended to be converted to a film in order to improve the mechanical properties and/or the convertibility of the polyamide.

As regards their preparation, the copolymers of the invention can be prepared by any means which makes it possible to couple together the polyamide blocks and the polyether blocks. In practice, essentially two processes are used, one a “two-stage” process and the other a “single-stage” process. In the two-stage process, first the polyamide blocks are manufactured and then, in a second stage, the polyamide blocks and the polyether blocks are coupled together. In the single-stage process, the polyamide precursors, the chain regulator (or the dicarboxylic acid or the diamine in stoichiometric excess) and the polyether are mixed; a polymer is then obtained having essentially polyether blocks, polyamide blocks of highly variable length but also the various reactants which have reacted randomly and which are distributed randomly (statistically) along the polymer chain.

Whether in one or two stages, it is advantageous to operate in the presence of a catalyst. Use may be made of the catalysts disclosed in U.S. Pat. Nos. 4,331,786, 4,115,475, 4,195,015, 4,839,441, 4,864,014, 4,230,838 and 4,332,920.

Use may also be made of a process in which first the polyetherdiol is converted to polyetherdiamine, -diacid or -diisocyanate in order to subsequently react it with the PA-diacid or -diamine block.

1. A water-proof breathable product comprising a copolymer comprising polyamide blocks and polyether blocks of the general formula
-[PA-PE]ₙ- (I)
wherein
PA represents a polyamide block;
PE represents a polyether block; and
n represents the number of -PA-PE- units of the said copolymer,
and wherein
the said blocks originate either entirely from polytrimethylene ether glycol (PO3G) or they originate from a blend or a copolymer of PO3G and ef at least one compound selected from the group consisting of polyethylene ether glycol (PEG), polypropylene ether glycol (PPG), polytetramethylene ether glycol (PTMG), polyhexamethylene ether glycol, and copolymers of tetrahydrofuran (THF) and of 3-alkyltetrahydrofuran (3MeTHF); wherein said product is breathable.

2. The water-proof breathable product according to claim 1, wherein the said PE blocks have a molecular weight<800.

3. The water-proof breathable product according to claim 2, wherein the molecular weight of the said PE blocks is at least 250.

4. The water-proof breathable product according to claim 1, wherein the molecular weight of the said PE blocks is between 250 and 650.

5. The water-proof breathable product according to claim 1, wherein at least 10%, by weight of the PE blocks originate from polytrimethylene ether glycol (% by weight with respect to the total weight of the said PE blocks).

6. The water-proof breathable product according to claim 1, wherein the percentage by weight of PA blocks with respect to the total weight of the said copolymer is at least 10%.

7. The water-proof breathable product according to claim 1, wherein the PA blocks have a number-average molecular weight of at least 300, ranging up to 10,000.

8. The water-proof breathable product according to claim 1, wherein the PE blocks have a number-average molecular weight of at least 250, ranging up to 5000.

9. The water-proof breathable product according to claim 1, wherein n ranges from 1, up to a mean of 60.

10. The water-proof breathable product according to claim 1, wherein the PA blocks are with carboxyl ends so that the bonds between the PA and PE blocks are ester bonds.

11. The water-proof breathable product according to claim 10, wherein the PA blocks comprising carboxyl ends are the condensation product of a lactam, of an amino acid, or of a combination of the two with a dicarboxylic acid.

12. The water-proof breathable product according to claim 10, wherein the PA blocks comprising carboxyl ends are the condensation product of a dicarboxylic acid, and of a diamine.

13. The water-proof breathable product according to claim 1, characterized in that the PA blocks are chosen from PA 6, PA 6,6, PA 6,9, PA 6,10, PA 6,12, PA 6,14, PA 6,18, PA Pip,10 and PA 9,6.

14. The water-proof breathable product of claim 1, wherein said product is a thermoplastic polymer comprising a membrane formed of said copolymer comprising polyamide blocks and polyether blocks as a membrane for selective gas diffusion.

15. The water-proof breathable product according to claim 5 wherein 85 to 100% by weight of the PE blocks originate from polytrimethylene ether glycol (% by weight with respect to the total weight of the said PE blocks).

16. The water-proof breathable product according to claim 6, wherein the percentage by weight of PA blocks with respect to the total weight of the said copolymer is between 40 and 60%.

17. The water-proof breathable product according to claim 9, wherein n ranges from 6 and ranging up to a mean of 25.

18. The water-proof breathable product according to claim 11, wherein said lactam is a C₄-C₁₄ lactam, said amino acid is a C₄-C₁₄ amino acid, and said dicarboxylic acid is a C₄-C₂₀ dicarboxylic acid.

19. The water-proof breathable product according to claim 12, wherein said dicarboxylic acid is a (C₄-C₂₀ alkane)dicarboxylic acid, and said diamine is a C₂-C₂₀ diamine.

20. A polyamide film composition having improved mechanical properties and/or convertibility comprising:
a) polyamide 6, polyamide 6.6 or copolyamide based on 6/6.6; and
b) a copolymer additive comprising polyamide blocks and polyether blocks of the general formula
-[PA-PE]ₙ- (I)
wherein
PA represents a polyamide block;
PE represents a polyether block; and
n represents the number of -PA-PE- units of the said copolymer,
and wherein
said blocks originate either entirely from polytrimethylene ether glycol (PO3G) or they originate from a blend or a copolymer of PO3G and at least one compound selected from the group consisting of polyethylene ether glycol (PEG), polypropylene ether glycol (PPG), polytetramethylene ether glycol (PTMG), polyhexamethylene ether glycol, and copolymers of tetrahydrofuran (THF) and of 3-alkyltetrahydrofuran (3MeTHF).
